(19) United States
(12) Patent Application Publication
(10) Pub. No.: US 2024/0313571 A1
(43) Pub. Date: Sep. 19, 2024

(54) POWER MANAGEMENT FOR VEHICLES

(71) Applicant: Rivian IP Holdings, LLC, Plymouth, MI (US)

(72) Inventors: Emily Elaine BIDGOOD, Costa Mesa, CA (US); Martin HERMEZ, West Bloomfield, MI (US); Terrin CHAN, San Diego, CA (US)

(21) Appl. No.: 18/300,331

(22) Filed: Apr. 13, 2023

Related U.S. Application Data
(63) Continuation of application No. 18/121,544, filed on Mar. 14, 2023, now abandoned.

(51) Int. Cl. H02J 7/34; B60R 16/033

(52) U.S. Cl. CPC H02J 7/342; B60R 16/033

(57) ABSTRACT

In techniques for managing electrical components of a vehicle, geographical location information regarding a vehicle and an authorized user of the vehicle may indicate that the vehicle will likely remain unused by the authorized user for an extended time period, and a vehicle may be put into a mode of lower power use than when the vehicle is expected to be used more imminently. For example, a power mode command corresponding to a user's location may be received at a vehicle, and the vehicle may transition from a first power mode to a second power mode, where the second power mode uses less power than the first power mode.

### CROSS REFERENCE TO RELATED APPLICATIONS

This application is a continuation of U.S. patent application Ser. No. 18/121,544, entitled “POWER MANAGEMENT FOR VEHICLES,” filed on Mar. 14, 2023, the disclosure of which is hereby incorporated herein in its entirety.

### INTRODUCTION

Vehicles may include one or more electrically powered components. In addition to, for example, electrically powered motors and actuators, vehicles may also include one or more electric control units (ECUs) that control various aspects of the vehicle, such as electronic control of drive motors, electronic dashboard displays, and/or vehicle security and door lock systems. Furthermore, improvements to the power management functions of these vehicles can prolong the battery life and usability of these vehicles.

### BRIEF SUMMARY

The present description relates generally to power management, including, for example, power management for vehicles. One or more implementations of the subject technology relate to one or more vehicle power save modes that may be activated when a vehicle is likely to be unused for an extended period of time, such as when the primary authorized user of the vehicle is determined to be more than a pre-configured distance from the vehicle and/or based on a location of the vehicle. For example, when a user is far from the vehicle (e.g., greater than 30 miles), and unlikely to return for an extended period of time, one or more vehicle systems can be put into a power saving state (or a deeper power saving state). The subject technology may, for example, provide for extended duration between battery recharges, improved electrical power efficiency, reduced electrical power usage, reduced frequency of vehicle charging from an external power source, and/or reduced frequency of secondary battery charging from a primary battery within the vehicle. These benefits provided by the subject technology may, for example, reduce greenhouse gas emissions and may thereby facilitate combatting climate change.

In accordance with one or more aspects of the subject technology, a processor of a vehicle operating in a first power mode may receive, over a network, a power mode command that corresponds to an authorized user of the vehicle being more than a threshold distance from the vehicle. Responsive to receiving the power mode command, the processor may cause a transition from the first power mode to a second power mode, where the second power mode uses less power than the first power mode. In some aspects, use of the second power mode may be based on an indication of an amount of time that the authorized user is expected to be more than the threshold distance from the vehicle; the power mode command may be received from a server associated with the vehicle or a user device associated with the authorized user; and the transition to the second power mode may reduce a frequency of charging a secondary battery from a primary battery, reduce a control clock frequency or power voltage of at least one processor in the vehicle, reduce a status query frequency, and/or disable a power supply to at least one processor of the vehicle.

In accordance with one or more aspects of the subject technology, a first location of a vehicle and a second location of an authorized user of the vehicle may be received, and power consumption of the vehicle may be controlled based at least in part on whether the second location of the authorized user is more than a pre-configured distance from the first location of the vehicle. In an aspect, the first location of the vehicle may be received from a telematics system and the second location of the authorized user may be received from a user device of the authorized user. In one or more implementations, responsive to determining, based at least in part on the first and second locations, that the authorized user of the vehicle has moved outside of the pre-configured distance from the vehicle, a command may be transmitted to a processor of the vehicle to cause the vehicle to transition from a first power mode to a second power mode, where the second power mode utilizes less power than the first power mode. In one or more implementations, responsive to determining, based at least in part on the first and second locations, that the authorized user of the vehicle has moved inside of the pre-configured distance from the vehicle, another command may be transmitted to the processor of the vehicle to cause the vehicle to transition from the second power mode to the first power mode. In one or more implementations, when the authorized user and another authorized user are registered as authorized users of the vehicle, a third location of the other authorized user may be received and the command to transition power modes may be transmitted to the processor of the vehicle based at least in part on the first, second, and third locations, such as when both the authorized user and the other authorized user are determined to be outside of the pre-configured distance from the vehicle.

In one aspect, a system may include one or more processors configured to perform one or more aspects of the subject technology described herein. In another aspect, a non-transitory machine readable medium may include instructions that, when executed by one or more processors, cause the one or more processors to perform one or more aspects of the subject technology described herein.

### BRIEF DESCRIPTION OF THE DRAWINGS

Certain features of the subject technology are set forth in the appended claims. However, for purpose of explanation, several implementations of the subject technology are set forth in the following figures.

FIG. 1 illustrates an example network environment for providing power management for vehicles in accordance with one or more implementations.

FIG. 2 illustrates a vehicle including a system for managing vehicle power modes in accordance with one or more implementations.

FIG. 3 illustrates a vehicle including an electrical power distribution system in accordance with one or more implementations.

FIG. 4 illustrates a flow diagram of an example process for managing vehicle power modes in accordance with one or more implementations.

FIG. 5 illustrates a flow diagram of an example process for managing vehicle power modes in accordance with one or more implementations.

FIG. 6 illustrates an example computing device with which aspects of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

In electrically powered vehicles, one or more electrical systems (and/or electrical control units (ECUs)) may be maintained in a powered-on state even when the vehicle is powered off by a user. For example, one or more electrical systems may remain powered on, such as to respond to user authentication requests, respond to closure activation requests, respond to requests to activate/deactivate security mechanisms (e.g., locks), and the like. Although these electrical systems may, in one or more implementations, draw less electrical power while the vehicle is in a powered-off state (e.g., as opposed to when the vehicle is in a powered-on state), these and other electrical systems may unnecessarily consume electrical power when the authorized user of the vehicle is unlikely to return to the vehicle for an extended period of time, such as when the authorized user is determined to be more than a threshold distance from the vehicle.

Implementations of the subject technology described herein provide for causing a vehicle to enter a low power mode when the primary authorized user of the vehicle is determined to be more than a threshold distance away from the vehicle (and therefore unlikely to return to the vehicle for an extended period of time). Since the primary authorized user is not expected to return to the vehicle for an extended period of time, one or more electrical systems, such as electrical systems for responding to proximate user requests, may be powered off completely, or substantially completely, thereby providing for reduced power consumption relative to the vehicle's powered-off state. Since one or more electrical systems of an electric vehicle may be powered by a secondary or auxiliary battery of the vehicle, which itself may be charged from the vehicle's primary battery, reducing power consumption in the vehicle's powered-off state may reduce the number of times the auxiliary or secondary battery needs to be recharged from the primary battery of the vehicle, which may thereby provide an extended charge duration for the primary battery. Furthermore, once configured the subject system may perform these and other power management/conservation functions passively, e.g., without intervention from the primary authorized user.

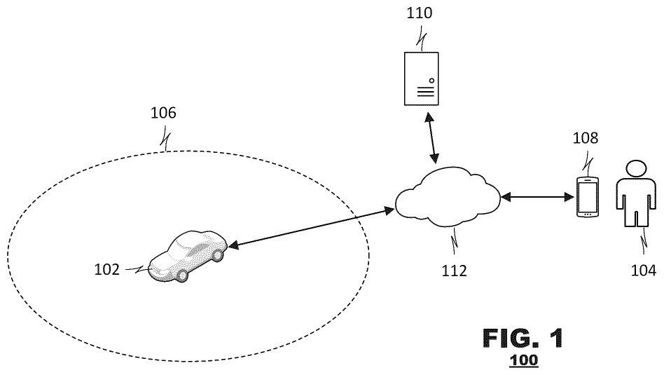

FIG. 1 illustrates an example network environment 100 for providing power management for vehicles in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes a vehicle 102, an electronic device 108 of a primary authorized user 104 of the vehicle 102, a server 110, and a network 112. The network 112 may communicatively (directly or indirectly) couple, for example, any two or more of the vehicle 102, the electronic device 108, or the server 110. In one or more implementations, the network 112 may be an interconnected network of devices that may include, and/or may be communicatively coupled to, the Internet. The network 112 may include one or more cellular networks, one or more telematics networks, one or more wide or local area networks, and/or generally any network that may communicatively couple two or more devices. For explanatory purposes, the network environment 100 is illustrated in FIG. 1 as including a single vehicle 102, a single electronic device 108, and a single server 110; however, the network environment 100 may include any number of vehicles, electronic devices, and/or servers.

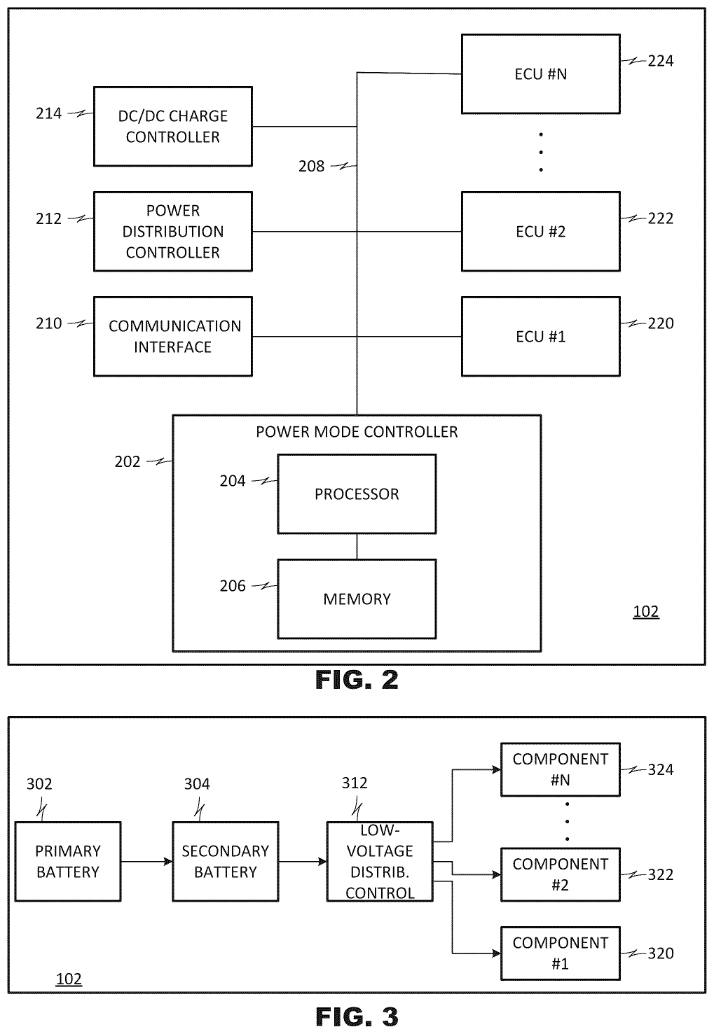

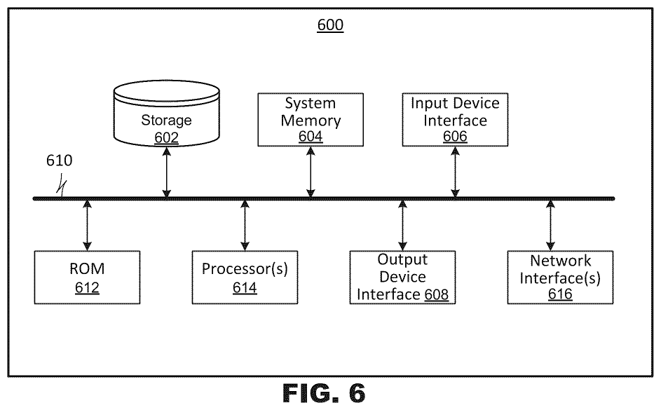

The electronic device 108 may be, for example, a portable computing device such as a mobile phone, a tablet device, a wearable device such as a smartwatch, a band, and the like, or any other appropriate device that includes, for example, one or more wireless interfaces, such as WLAN radios, cellular radios, Bluetooth radios, Zigbee radios, near field communication (NFC) radios, and/or other wireless radios. The electronic device 108 may be, and/or may include all or part of, the computing device discussed below with respect to FIG. 6. In some implementations, electronic device 108 may include a software application associated with the vehicle 102. In one or more implementations, the vehicle 102 may be any vehicle that includes any of the aforementioned wireless interfaces and/or radios for communication with the server 110 and/or the electronic device 108. The vehicle 102 may be, and/or may include all or part of, the vehicle discussed below with respect to FIGS. 2 and 3, and/or the computing device discussed below with respect to FIG. 6.

The server 110 may be, and/or may include all or part of the computing device discussed below with respect to FIG. 6. The server 110 may include one or more servers, such as a cloud of servers. For explanatory purposes, a single server 110 is shown and discussed with respect to various operations. However, these and other operations discussed herein may be performed by one or more servers, and each different operation may be performed by the same or different servers.

In one or more implementations, the primary authorized user 104 may have a user account registered to and/or associated with the vehicle 102. For example, the server 110 may provide a system that allows the primary authorized user 104 to register their user account as the primary authorized user account for the vehicle 102. The primary authorized user may access their user account and/or the vehicle through one or more applications (and/or a web browser interface) on the electronic device 108. The primary authorized user 104 may further possess one or more other authorization devices (not shown) that may allow access to the vehicle 102, such as a wrist band, a watch or generally any device that includes any of the aforementioned wireless interfaces and/or radios for communication with the vehicle 102.

In operation, the vehicle 102 may transmit and/or provide an indication of its geographic location (e.g., as determined from a global positioning system (GPS) or other position estimation system) to the server 110 (and/or to the electronic device 108) via the network 112, such as via a telematics network. The electronic device 108 may transmit and/or provide an indication of its geographic location (e.g., as determined from a GPS or other position estimation system) to the server 110 (and/or to the vehicle 102). A power management service, e.g., operating on the server 110, may determine when the geographic location of the electronic device 108 is inside or outside of a threshold distance 106 of the geographic location of the vehicle 102. For explanatory purposes the power management service is described herein as being implemented on the server 110; however, in one or more implementations at least a portion of the power management service may be implemented on the electronic device 108, on the vehicle 102, and/or on any other device.

When the server 110 determines that the geographic location of the electronic device 108 is inside of the threshold distance 106 from vehicle 102, the server 110 may transmit a command to the vehicle 102 to cause the vehicle 102 to operate in a first power mode, e.g., while powered off (and/or the vehicle 102 may operate in the first power mode by default while powered off). When the geographic location of the electronic device 108 is determined to be outside of the threshold distance 106 from the vehicle 102, the server 110 may transmit a command to the vehicle 102 to cause the vehicle 102 to operate in a second power mode, e.g., while powered off, where the second power mode uses less power than the first power mode.

The threshold distance 106 may be configured to be any distance from which the primary authorized user 104 is unlikely to return to the vehicle 102 for an extended period of time, such as, for example 30 or more miles. For illustrative purposes, the threshold distance 106 is illustrated as an oval around the vehicle 102; however, the threshold distance 106 may be any shape and/or may be configured, for example, as a geofence around the vehicle that has any geometric or freeform shape.

In one or more implementations, the threshold distance 106 may be configured differently depending on the location of the vehicle 102 and/or user behavior associated with the location of the vehicle 102. For example, if the vehicle 102 is parked in a long term parking lot at a university where the primary authorized user 104 attends and/or lives on-campus, the primary authorized user 104 may be within the threshold distance 106 of the vehicle 102 during the school week but may be unlikely to use the vehicle 102 during the school week (e.g., based on historical user behavior). Accordingly, in this instance the threshold distance 106 may be configured to be closer to the vehicle 102 when the vehicle is parked in the long term parking lot at such a university such that the vehicle 102 may enter the low power mode described herein during the school week. In another example, selection of power modes and/or threshold distance may be based on the location of vehicle 102 being in a long-term parking lot at an airport. In one or more implementations selection of a power mode and/or a threshold distance may be based on historical behavior of the primary authorized user 104, and/or historical behavior of other users at a particular location.

FIG. 2 illustrates a vehicle 102 including a system for managing vehicle power modes in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The vehicle 102 may include a power mode controller 202, a communication interface 210, a power distribution controller 212, a direct current (DC)/DC charge controller 214, and one or more electric control units (ECUs) 220-224. The power mode controller 202 may include a processor 204 and memory 206.

In operation, the power mode controller 202 may communicate with one or more devices outside the vehicle (such as the server 110 and/or the electronic device 108 of FIG. 1) via the communication interface 210, including sending or receiving location information or a power mode command. The communication interface 210 may provide communications over one or more wide area networks, such as via the internet and/or a cellular phone network. The power mode controller 202 may manage various power modes of the vehicle 102. For example, the power mode controller 202 may control charging of a secondary battery from a primary battery by control of the DC/DC charge controller 214, such as by altering a frequency of charging the secondary battery, or altering voltage thresholds used to initiate charging of the secondary battery. The power mode controller 202 may also control localized power modes of individual electrical components within the vehicle 102, for example by changing a local power mode of an electrical component in the vehicle 102, and/or by reducing the electrical power supplied to an electrical component in the vehicle.

In one or more implementations, the power mode controller 202 may control the electrical power supplied to individual devices in the 102 vehicle via the power distribution controller 212. The power distribution controller 212 may selectively alter electrical power supplied to the electrical devices and/or components of the vehicle 102. For example, a voltage and/or current supplied to an individual component or subset of components may be reduced or eliminated.

In one or more implementations, the power mode controller 202 may send a local power mode command to one or more of the ECUs 220-224, which may then cause the ECU (or an electrical component controlled by the ECU) to change how it consumes electrical power. The ECUs 220-224 may each control separate electrical components of the vehicle, such as vehicle key proximity sensors, door latch or lock actuators, interior passenger visual displays, cabin heating, ventilation, and air conditioning (HVAC), etc.

In one or more implementations, the vehicle 102 may include three or more power modes. A first power mode (“run” mode) may have most or all electrical components fully powered, and the vehicle 102 may be in operation (e.g. being driven) and/or ready to drive. A second power mode (“locked” mode) may have some components, such as HVAC, in a low-power or disabled state while other components, such as a user authorization component, in a fully powered state. This “locked” mode may preserve power when an authorized user is not proximate to the vehicle 102, but may leave a user authorization component (such as key fob radio component or Bluetooth ranging component) fully powered in order to detect when an authorized user is proximate. A third power mode (“deep sleep” mode) may include disabling or reducing functionality of the user authorization component. In an aspect, when an authorized user is sufficiently distant from the vehicle, the additional power savings from disabling the user authorization component may preserve power while that user is unlikely to need access to, or use, of the vehicle.

In one or more implementations, one or more of the power mode controller 202, the processor 204, the memory 206, the communication interface 210, the power distribution controller 212, the DC/DC charge controller 214, one or more of the ECUs 220-224, and/or one or more portions thereof, may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

FIG. 3 illustrates a vehicle 102 including an electrical power distribution system in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The vehicle 102 may include a primary battery 302, a secondary battery 304, a low-voltage distribution controller 312, and one or more electrically powered components 320-324. The primary battery 302 may be a high-capacity, high voltage (e.g., 200V) battery. The secondary battery 304 may have a lower energy capacity than primary battery 302, and may operate at a lower voltage (e.g., 12V) for powering lower voltage electrical components 320-324. In one or more implementations, the DC/DC charge controller 214 (FIG. 2) may control charging of the secondary battery 304 using power supplied by the primary battery 302.

The low-voltage distribution controller 312 may provide one or more switches for enabling or disabling power supply from the secondary battery 304 to one or more of the electrical vehicle components 320-324. In other aspects, the low-voltage distribution controller 312 may adjust a voltage supplied to electrical vehicle components 320-324, for example at discrete voltage levels from zero volts up to the voltage supplied by the secondary battery 304. In one or more implementations, the low-voltage distribution controller 312 may be a part of, or controlled by, power distribution controller 212 (FIG. 2). In one or more implementations, one or more of the electrical vehicle components 320-324 may include one or more of the ECUs 220-224 (FIG. 2), and/or may be electrical components controlled by corresponding ECUs.

In other aspects not depicted in FIG. 3, the primary battery 302 may directly power some high-voltage vehicle components, such as drive motors or HVAC systems, and/or power from the primary battery 302 may also be routed through a high-voltage distribution control (not depicted) for consumption by high-voltage vehicle components.

In one or more implementations, one or more of the low-voltage distribution controller 312, one or more of the electrical vehicle components 320-324, and/or one or more portions thereof, may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

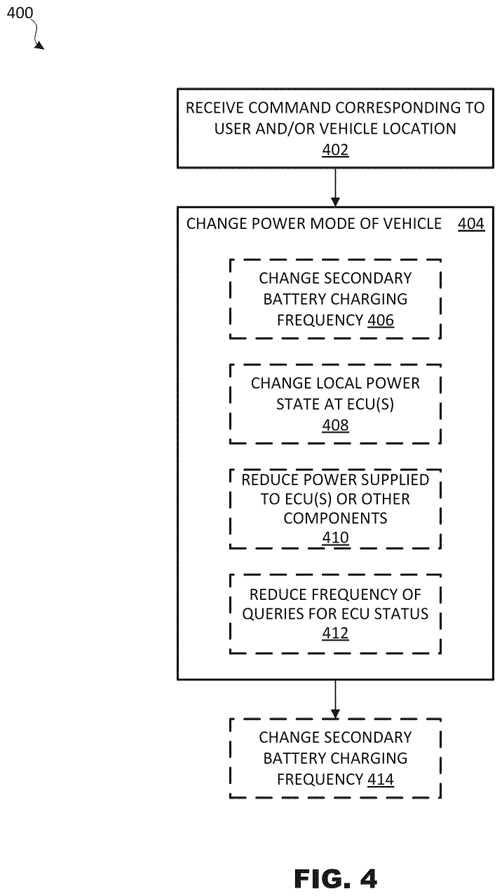

FIG. 4 illustrates a flow diagram of an example process 400 for managing vehicle power modes in accordance with one or more implementations. For explanatory purposes, the process 400 is primarily described herein with reference to the vehicle 102 of FIGS. 1-3, and the electronic device 108 and the server 110 of FIG. 1. However, the process 400 is not limited to the vehicle 102 of FIGS. 1-3, or the electronic device 108 and the server 110 of FIG. 1, and one or more blocks (or operations) of the process 400 may be performed by one or more other components (e.g., of the vehicle 102) and/or other suitable devices. Further for explanatory purposes, the blocks of the process 400 are described herein as occurring in serial, or linearly. However, multiple blocks of the process 400 may occur in parallel. In addition, the blocks of the process 400 need not be performed in the order shown and/or one or more blocks of the process 400 need not be performed and/or can be replaced by other operations.

The process 400 is initiated when a vehicle 102 (e.g., via a processor 204 of the vehicle 102) receives a power mode command corresponding to a location of a primary authorized user 104 of the vehicle 102 and./or a location of the vehicle (402). Responsive to receipt of the power mode command, the vehicle 102 may change a power mode based on the received power mode command (404). The power mode command may indicate, for example that a distance between the vehicle 102 and the primary authorized user 104 of the vehicle 102 is more or less than a threshold distance 106. The changing of the power mode of the vehicle 102 may include, for example, changing a secondary battery charging frequency (406), changing a local power state at one or more an ECUs (408), reducing power supplied to one or more ECUs and/or other vehicle components (410), and/or reducing a frequency of queries for ECU status (412). In some implementations, a query for a status of an ECU may cause the ECU to transition into a state that uses more power, and hence less frequent queries may reduce the power used over time. In one or more implementations, the changing of the power mode of the vehicle 102 may further include changing a dynamic voltage and frequency scaling state of one or more components (e.g., processors) in the vehicle 102. In another aspect, a secondary battery charging frequency may be changed (414) after changing the vehicle power mode (404).

In some aspects, the power mode command may be received (402) from devices such as a server (e.g., the server 110 of FIG. 1), a device associated with an authorized user (e.g., the electronic device 108 of FIG. 1), or another device (not pictured) with access to location information of the vehicle and/or authorized user. In other aspects, instead of receiving a power mode command, location information (regarding the vehicle 102 and/or an electronic device 108 associated with a primary authorized user 104) may be received or locally determined, and then selection of a power mode for the vehicle 102 may be made based on the location information.

In an aspect, a vehicle may have multiple authorized users and/or multiple devices associated with authorized user(s). For example, two authorized users may each be associated with a respective device (such as the electronic device 108 of FIG. 1). Alternately or in addition, a single authorized user may be associated with multiple devices, each device with an ascertainable geographical location. In these cases, the second (lower) power mode may only be selected when all authorized users (and/or all devices associated with authorized users) are more than the threshold distance from the vehicle. Alternately, one user or associated device may be considered primary for the purposes of selecting a power mode from a distance to the vehicle.

In one example, the first (higher) power mode may correspond to the “on” or “locked” mode described above, while the second (lower) power mode may correspond to the “deep sleep” mode described above. In this example, user authorization components in the vehicle (such as NFC, Bluetooth, or key fob radio transceivers and associated components) may be fully enabled in the first power mode, and partially or fully disabled in the second power mode.

In an aspect, a vehicle power mode may also transition from a lower power mode to a higher power mode based on location information. For example, when an authorized user (or the user's associated device) transitions from outside the threshold distance 106 to inside the threshold distance 106, a received power mode command may indicate that the vehicle should transition from the second power mode to the first power mode.

In another aspect, a power mode (or a power mode command) may be selected based on both a distance from the vehicle and a time duration at the distance. In one example, a transition to the second power mode may only be selected when the user is expected to remain outside the threshold distance from the vehicle for at least a threshold time (such as one hour or one week). In a second example, a transition to the second power mode may only be selected after the authorized user has already remained outside the threshold distance from the vehicle for at least a threshold time. In a third example, there may be two distance thresholds, where the second power mode is selected when: 1) the user is expected to be (or has already been) outside a first, closer, threshold distance from the vehicle for a time threshold duration; or 2) the user is outside a second, further, threshold distance from the vehicle without respect to any time duration.

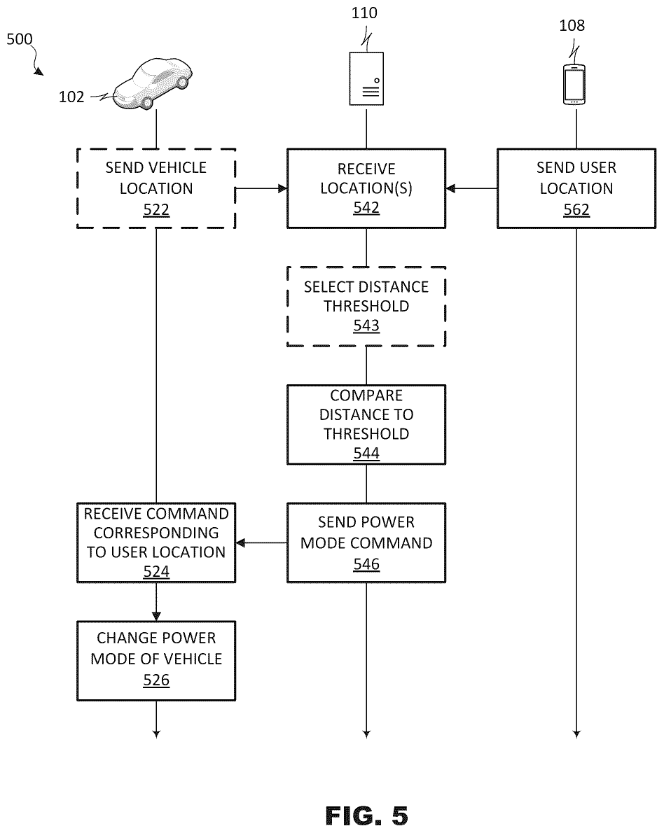

FIG. 5 illustrates a flow diagram of an example process 500 for managing vehicle power modes in accordance with one or more implementations. For explanatory purposes, the process 500 is primarily described herein with reference to the vehicle 102 of FIGS. 1-3, and the electronic device 108 and the server 110 of FIG. 1. However, the process 500 is not limited to the vehicle 102 of FIGS. 1-3, or the electronic device 108 and the server 110 of FIG. 1, and one or more blocks (or operations) of the process 500 may be performed by one or more other components (e.g., of the vehicle 102) and/or other suitable devices. In an aspect, operations depicted in FIG. 5 that are performed by the electronic device 108 may be performed on the electronic device 108 by an app associated with the vehicle 102. Further for explanatory purposes, the blocks of the process 500 are described herein as occurring in serial, or linearly. However, multiple blocks of the process 500 may occur in parallel. In addition, the blocks of the process 400 need not be performed in the order shown and/or one or more blocks of the process 400 need not be performed and/or can be replaced by other operations.

The process 500 is initiated when the vehicle 102 transmits its location to the server 110 (522), such as via a telematics connection. The electronic device 108 of the primary authorized user 104 may also transmit its location to the server 110 (562), and the server 110 may receive the locations of the vehicle 102 and the electronic device 108 (542). The server 110 may retrieve the threshold distance for the vehicle 102 and the server 110 may compare the distance between the vehicle 102 and the electronic device 108 of the primary authorized user 104 to the threshold distance 106 (544).

The server 110 may then transmit a power mode command to the vehicle 102 based on the comparison (546). For example, when the comparison indicates that the electronic device 108 has moved outside of the threshold distance the server 110 may transmit a power mode command indicating that the vehicle 102 should enter the low power state described herein. The vehicle 102 (e.g., via the communication interface 210) may receive the power mode command from the server 110 and may change the power mode of the vehicle 102 accordingly (526).

Aspects of process 500 may include features described above with respect to, for example, FIG. 4. For example, changing a power mode of the vehicle (526) may include optional operations for changing a secondary battery charging frequency, changing a local power state at one or more an ECUs, and/or reducing power supplied to one or more ECUs or other vehicle components, as described above (e.g., with regard to 406, 408, 410).

In an optional aspect of FIG. 5, a threshold distance may be selected (543) for use in the comparison of box 544. The threshold distance may be based, for example, on the location of the vehicle and/or prior behavior of the primary authorized user or other users. For example, when the vehicle is parked at a location known as a long term parking area, such as a long term parking lot at an airport or college campus, a threshold distance may be selected to be smaller or greater than a default threshold distance.

In another aspect, the threshold distance may be based on past or expected behavior of the primary user, and may be based on past behavior at a particular vehicle location. For example, if a primary user rarely parks for an extended period at a location such as a work office parking lot, a threshold distance may be selected based on this behavior. Alternately, if a primary user leaves the vehicle unused for a long weekend when parked near a vacation home, a threshold distance may be selected based on this behavior. In a third aspect, the threshold distance may be based on past or expected behavior of users other than the primary user, and may be based on such past behavior at a particular vehicle location. For example, a collection of behavior data from many users, including users that are not associated with the vehicle, may be used to select a threshold distance. In an aspect, a threshold distance may be selected by the same device that performs a comparison with the threshold, as in FIG. 5, or the threshold distance may be selected by another device.

Some implementations of the subject technology may provide improved vehicle management when a battery may be depleted. In some implementations, costs associated with depleting a battery may differ for different battery types. For example, depleting a high voltage battery, such as primary battery 302 (FIG. 3), may require towing a car to a service center for repairs, while a depleted low voltage battery, such as a 12V battery or secondary battery 304 (FIG. 3), may require only a jump-start from another 12V power source without needing to tow the vehicle. In these implementations, battery depletion of a primary battery may be prevented by disabling charging of the secondary battery from the primary battery. For example, improved battery depletion management may include disabling charging of a secondary battery from a primary battery when the primary battery drops below a charging level threshold, where the charging level threshold is based on a distance between the vehicle and a closest charging location. In aspects, battery depletion management techniques may be combined with the vehicle power save modes described in this disclosure, for example regarding FIGS. 1-5.

In an aspect, methods such as depicted in FIG. 5 may further include determining a charge level threshold of a primary battery of the vehicle based on a distance between the vehicle and a charging location. When the charge level of the primary battery is above the charge level threshold, allowing the primary battery to be used to recharge a secondary battery, and when the charge level of the primary battery is below the charge level threshold, disabling recharging of the secondary battery from the primary battery. In an aspect, the disabling recharging of the secondary battery occurs in response to a determination that the authorized user is not interacting with the vehicle for a time period that exceeds a time threshold. In another aspect, the method may further include determining an amount of energy or power required for the vehicle to reach the charging location, wherein the charge level threshold is determined based on the amount of energy required. In one aspect, the charging location may be a closest charging location to the vehicle.

FIG. 6 illustrates an example computing device 600 with which aspects of the subject technology may be implemented in accordance with one or more implementations. For example, computing device 600 may be used for performing the processes 400 or 500 (FIG. 4, 5). The computing device 600 can be, and/or can be a part of, any computing device or server for generating the features and processes described above, including but not limited to a laptop computer, a smartphone, a tablet device, a wearable device such as a goggles or glasses, an earbud or other audio device, a case for an audio device, and the like. The computing device 600 may include various types of computer readable media and interfaces for various other types of computer readable media. The computing device 600 includes a permanent storage device 602, a system memory 604 (and/or buffer), an input device interface 606, an output device interface 608, a bus 610, a ROM 612, one or more processing unit(s) 614, one or more network interface(s) 616, and/or subsets and variations thereof.

The bus 610 collectively represents all system, peripheral, and chipset buses that communicatively connect the numerous internal devices of the computing device 600. In one or more implementations, the bus 610 communicatively connects the one or more processing unit(s) 614 with the ROM 612, the system memory 604, and the permanent storage device 602. From these various memory units, the one or more processing unit(s) 614 retrieves instructions to execute and data to process in order to execute the processes of the subject disclosure. The one or more processing unit(s) 614 can be a single processor or a multi-core processor in different implementations.

The ROM 612 stores static data and instructions that are needed by the one or more processing unit(s) 614 and other modules of the computing device 600. The permanent storage device 602, on the other hand, may be a read-and-write memory device. The permanent storage device 602 may be a non-volatile memory unit that stores instructions and data even when the computing device 600 is off. In one or more implementations, a mass-storage device (such as a magnetic or optical disk and its corresponding disk drive) may be used as the permanent storage device 602.

In one or more implementations, a removable storage device (such as a floppy disk, flash drive, and its corresponding disk drive) may be used as the permanent storage device 602. Like the permanent storage device 602, the system memory 604 may be a read-and-write memory device. However, unlike the permanent storage device 602, the system memory 604 may be a volatile read-and-write memory, such as random-access memory. The system memory 604 may store any of the instructions and data that one or more processing unit(s) 614 may need at runtime. In one or more implementations, the processes of the subject disclosure are stored in the system memory 604, the permanent storage device 602, and/or the ROM 612. From these various memory units, the one or more processing unit(s) 614 retrieves instructions to execute and data to process in order to execute the processes of one or more implementations.

The bus 610 also connects to the input and output device interfaces 606 and 608. The input device interface 606 enables a user to communicate information and select commands to the computing device 600. Input devices that may be used with the input device interface 606 may include, for example, alphanumeric keyboards and pointing devices (also called “cursor control devices”). The output device interface 608 may enable, for example, the display of images generated by computing device 600. Output devices that may be used with the output device interface 608 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 6, the bus 610 also couples the computing device 600 to one or more networks and/or to one or more network nodes through the one or more network interface(s) 616. In this manner, the computing device 600 can be a part of a network of computers (such as a LAN, a wide area network (“WAN”), or an Intranet, or a network of networks, such as the Internet. Any or all components of the computing device 600 can be used in conjunction with the subject disclosure.

In one or more implementations, the system memory 604 may store one or more feature extraction models, one or more gesture prediction models, one or more gesture detectors, one or more (e.g., virtual) controllers (e.g., sets of gestures and corresponding actions to be performed by the computing device 600 or another electronic devices when specific gestures are detected), voice assistant applications, and/or other information (e.g., locations, identifiers, location information, etc.) associated with one or more other devices, using data stored locally in system memory 604. Moreover, the input device interface 606 may include suitable logic, circuitry, and/or code for capturing input, such as audio input, remote control input, touchscreen input, keyboard input, etc. The output device interface 608 may include suitable logic, circuitry, and/or code for generating output, such as audio output, display output, light output, and/or haptic and/or other tactile output (e.g., vibrations, taps, etc.).

The sensors included in or connected to input device interface 606 may include one or more ultra-wide band (UWB) sensors, one or more inertial measurement unit (IMU) sensors (e.g., one or more accelerometers, one or more gyroscopes, one or more compasses and/or magnetometers, etc.), one or more image sensors (e.g., coupled with and/or including an computer-vision engine), one or more electromyography (EMG) sensors, optical sensors, light sensors, image sensors, pressure sensors, strain gauges, lidar sensors, proximity sensors, ultrasound sensors, radio-frequency (RF) sensors, platinum optical intensity sensors, and/or other sensors for sensing aspects of the environment around and/or in contact with the computing device 600 (e.g., including objects, devices, and/or user movements and/or gestures in the environment). The sensors may also include motion sensors, such as inertial measurement unit (IMU) sensors (e.g., one or more accelerometers, one or more gyroscopes, and/or one or more magnetometers) that sense the motion of the computing device 600 itself.

In one or more implementations, system memory 604 may store a machine learning system that includes one or more machine learning models that may receive, as inputs, outputs from one or more of sensor(s). The machine learning models may have been trained based on outputs from various sensors corresponding to the sensors(s), in order to detect and/or predict a user gesture. When the computing device 600 detects a user gesture using the sensor(s) and the machine learning models, the computing device 600 may perform a particular action (e.g., raising or lowering a volume of audio output being generated by the computing device 600, scrolling through video or audio content at the computing device 600, other actions at the computing device 600, and/or generating a control signal corresponding to a selected device and/or a selected gesture-control element for the selected device, and transmitting the control signal to the selected device). In one or more implementations, the machine learning models may be trained based on a local sensor data from the sensor(s) at the computing device 600, and/or based on a general population of devices and/or users. In this manner, the machine learning models can be re-used across multiple different users even without a priori knowledge of any particular characteristics of the individual users in one or more implementations. In one or more implementations, a model trained on a general population of users can later be tuned or personalized for a specific user of a device such as the computing device 600.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FORAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components (e.g., computer program products) and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A. B. and C.

The predicate words “configured to,” “operable to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

1. A method comprising:
receiving, over a wireless network and by a processor of a vehicle operating in a first power mode, a power mode command that corresponds to a location of an authorized user of the vehicle being more than a threshold distance from the vehicle; and
responsive to receiving the power mode command, causing, by the processor, a transition from the first power mode to a second power mode, the second power mode using less power than the first power mode.

2. The method of claim 1, further comprising:
receiving an indication of an amount of time that the authorized user is expected to be more than the threshold distance from the vehicle; and
controlling power usage in the second power mode based at least in part on the amount of time that the authorized user is expected to be more than the threshold distance from the vehicle.

3. The method of claim 1, wherein the power mode command is received from at least one of: a server associated with the vehicle, or a user device associated with the authorized user.

4. The method of claim 1, wherein the vehicle comprises a primary battery and a secondary battery and the method further comprises:
causing power to be delivered to the vehicle from the secondary battery while operating in the first and second power modes.

5. The method of claim 4, further comprising:
causing the primary battery to recharge the secondary battery while operating in the first and second power modes.

6. The method of claim 5, wherein the secondary battery is recharged less frequently when operating in the second power mode than when operating in the first power mode.

7. The method of claim 4, wherein the primary battery comprises a higher number of volts than the second battery.

8. The method of claim 1, wherein the transition from the first power mode to the second power mode comprises at least one of:
reducing at least one of a frequency or voltage of at least one processor of the vehicle; or
disabling a supply of power to at least one processor of the vehicle.

9. The method of claim 1, further comprising:
receiving, over the network and by the processor of the vehicle operating in the second power mode, another power mode command that corresponds to the authorized user of the vehicle being less than the threshold distance from the vehicle; and
responsive to receiving the other power mode command, causing, by the processor, another transition from the second power mode to the first power mode.

10. A system comprising:
one or more processors configured to:
configure one or more electrical components of a vehicle to operate in a first power mode;
receive a command over a wireless network to transition from the first power mode to a second power mode, the command corresponding to a determination that an authorized user of the vehicle is more than a threshold distance from the vehicle; and
responsive to receipt of the command, configure the one or more electrical components of the vehicle to operate in the second power mode, the second power mode utilizing less power than the first power mode.

11. The system of claim 10, wherein the one or more processors is further configured to:
receive the command over a network from at least one of: a server associated with the vehicle, or a user device of the authorized user.

12. The system of claim 10, wherein the one or more processors is further configured to:
receive an indication of an amount of time that the authorized user is expected to be more than the threshold distance from the vehicle; and
manage operation of the one or more electrical components in the second power mode based at least in part on the amount of time.

13. The system of claim 12, wherein the vehicle comprises a primary battery and a secondary battery, the one or more electrical components draw power from the secondary battery when operating in the first and second power modes, and the primary battery is used to recharge the secondary battery during the first and second power modes.

14. The system of claim 13, wherein the one or more processors is further configured to:
manage operation of the one or more electrical components in the second power mode to minimize a number of recharges of the secondary battery over the amount of time.

15. The system of claim 13, wherein the one or more processors is further configured to:
initiate a conditioning operation for the primary battery based at least in part on the amount of time.

16. The system of claim 10, wherein the one or more processors is configured to configure the one or more electrical components of the vehicle to operate in the second power mode by:
causing a reduction in a frequency or a voltage corresponding to at least one of the one or more electrical components; or
preventing power from being provided to at least one of the one or more electrical components.

17. A non-transitory machine readable medium comprising instructions that, when executed by one or more processors, cause the one or more processors to perform operations comprising:
receiving a first location of a vehicle;
receiving a second location of an authorized user of the vehicle; and
controlling power consumption of the vehicle based at least in part on whether the second location of the authorized user is more than a pre-configured distance from the first location of the vehicle.

18. The non-transitory machine readable medium of claim 17, wherein the first location of the vehicle is received from a telematics system and the second location of the authorized user is received from a user device of the authorized user.

19. The non-transitory machine readable medium of claim 17, wherein controlling power consumption of the vehicle based at least in part on whether the second location of the authorized user is more than the pre-configured distance from the first location of the vehicle comprises:
responsive to determining, based at least in part on the first and second locations, that the authorized user of the vehicle has moved outside of the pre-configured distance from the vehicle, transmitting, to a processor of the vehicle, a command to cause the vehicle to transition from a first power mode to a second power mode, the second power mode utilizing less power than the first power mode; and
responsive to determining, based at least in part on the first and second locations, that the authorized user of the vehicle has moved inside of the pre-configured distance from the vehicle, transmitting, to the processor of the vehicle, another command to cause the vehicle to transition from the second power mode to the first power mode.

20. The non-transitory machine readable medium of claim 19, wherein the authorized user and another authorized user are registered as authorized users of the vehicle, and the operations further comprise:
receiving a third location of the other authorized user of the vehicle; and
responsive to determining, based at least in part on the first, second, and third locations, that both the authorized user and the other authorized user are outside of the pre-configured distance from the vehicle, transmitting, to the processor of the vehicle, the command to cause the vehicle to transition from the first power mode to the second power mode.
